(19) United States
(12) Patent Application Publication
(10) Pub. No.: US 2025/0223527 A1
(43) Pub. Date: Jul. 10, 2025

(54) BEER-FLAVORED BEVERAGE

(71) Applicant: Suntory Holdings Limited, Osaka-shi, Osaka (JP)

(72) Inventors: Hiroshi Nakamura, Osaka-shi, Osaka (JP); Tomoyuki Kishimoto, Osaka-shi, Osaka (JP); Tsubasa Tanikawa, Osaka-shi, Osaka (JP)

(73) Assignee: Suntory Holdings Limited, Osaka-shi, Osaka (JP)

(21) Appl. No.: 18/852,779

(22) PCT Filed: Mar. 23, 2023
(86) PCT No.: PCT/JP2023/011485

§ 371 Date: Sep. 30, 2024

(30) Foreign Application Priority Data
Mar. 31, 2022 (JP) 2022-060275
Mar. 31, 2022 (JP) 2022-060276
Mar. 31, 2022 (JP) 2022-060277
Mar. 31, 2022 (JP) 2022-060278
Mar. 31, 2022 (JP) 2022-060279

(51) Int. Cl. C12C 12/04; C12C 5/00

(52) U.S. Cl. CPC C12C 12/04; C12C 5/004

(57) ABSTRACT

A beer-taste beverage wherein an alcoholicity is 0.5 v/v % or more and 4.5 v/v % or less, and the content of isobutyraldehyde is 0.1 ppb by mass or more and 13 ppb by mass or less. According to the present invention, a beer-taste beverage having a novel taste in which an aftertaste is fresh can be provided.

### TECHNICAL FIELD

The present invention relates to a beer-taste beverage.

### BACKGROUND ART

With the diversification of the inclinations of the consumers in the recent years, the development of beer-taste beverages having various flavor characteristics has been desired. For example, Patent Publication 1 discloses a low alcohol or alcohol-free fermented malt-based beverage having an alcohol content of 0.7% by volume or less and a method of producing the same, and the patent publication discloses a production method in which a fermentability is 29% as a composition of a wort to be subjected to fermentation and the wort is fermented to an alcohol content of 0.7% by volume or so in a cold contact fermentation method as a fermentation method.

### RELATED ART REFERENCES

### Patent Publications

Patent Publication 1: Japanese Patent No. 5753257

### SUMMARY OF THE INVENTION

### Problems to be Solved by the Invention

However, in the beverage in Patent Publication 1 there are problems that an off-flavor originated from wort impairs the flavors of the beverage. Therefore, further improvement is desired.

The first embodiment of the present invention relates to the provision of a beer-taste beverage having a fresh aftertaste.

The second embodiment of the present invention relates to the provision of a beer-taste beverage having an inhibited wort odor.

The third embodiment of the present invention relates to the provision of a beer-taste beverage having an inhibited cheese-like smell.

The fourth embodiment of the present invention relates to the provision of a beer-taste beverage having an inhibited honey-like smell.

The fifth embodiment of the present invention relates to the provision of a beer-taste beverage having an inhibited immature odor.

### Means to Solve the Problems

The present invention relates to the following [1] to [15].
[1]A beer-taste beverage wherein an alcoholicity is 0.5 v/v % or more and 4.5 v/v % or less, and the content of isobutyraldehyde is 0.1 ppb by mass or more and 13 ppb by mass or less.
[2]A method of producing a beer-taste beverage containing adjusting an alcoholicity to 0.5 v/v % or more and 4.5 v/v % or less, and the content of isobutyraldehyde to 0.1 ppb by mass or more and 13 ppb by mass or less.
[3]A method of making aftertaste of a beer-taste beverage fresh containing adjusting an alcoholicity to 0.5 v/v % or more and 4.5 v/v % or less, and the content of isobutyraldehyde to 0.1 ppb by mass or more and 13 ppb by mass or less.
[4]A beer-taste beverage wherein an alcoholicity is 0.5 v/v % or more and 4.5 v/v % or less, and the content of 2-methylbutanal is 0.1 ppb by mass or more and 2.8 ppb by mass or less.
[5]A method of producing a beer-taste beverage containing adjusting an alcoholicity to 0.5 v/v % or more and 4.5 v/v % or less, and the content of 2-methylbutanal to 0.1 ppb by mass or more and 2.8 ppb by mass or less.
[6]A method of inhibiting a wort odor in a beer-taste beverage containing adjusting an alcoholicity to 0.5 v/v % or more and 4.5 v/v % or less, and the content of 2-methylbutanal to 0.1 ppb by mass or more and 2.8 ppb by mass or less.
[7]A beer-taste beverage wherein an alcoholicity is 0.5 v/v % or more and 4.5 v/v % or less, and the content of 3-methylbutanal is 0.1 ppb by mass or more and 8 ppb by mass or less.
[8]A method of producing a beer-taste beverage containing adjusting an alcoholicity to 0.5 v/v % or more and 4.5 v/v % or less, and the content of 3-methylbutanal to 0.1 ppb by mass or more and 8 ppb by mass or less.
[9]A method of inhibiting a cheese-like smell in a beer-taste beverage containing adjusting an alcoholicity to 0.5 v/v % or more and 4.5 v/v % or less, and the content of 3-methylbutanal to 0.1 ppb by mass or more and 8 ppb by mass or less.
[10]A beer-taste beverage wherein an alcoholicity is 0.5 v/v % or more and 4.5 v/v % or less, and the content of phenylacetaldehyde is 0.1 ppb by mass or more and 65 ppb by mass or less.
[11]A method of producing a beer-taste beverage containing adjusting an alcoholicity to 0.5 v/v % or more and 4.5 v/v % or less, and the content of phenylacetaldehyde to 0.1 ppb by mass or more and 65 ppb by mass or less.
[12]A method of inhibiting a honey-like smell in a beer-taste beverage containing adjusting an alcoholicity to 0.5 v/v % or more and 4.5 v/v % or less, and the content of phenylacetaldehyde to 0.1 ppb by mass or more and 65 ppb by mass or less,
[13]A beer-taste beverage wherein an alcoholicity is 0.5 v/v % or more and 4.5 v/v % or less, and the content of heptanal is 0.1 ppb by mass or more and 3.8 ppb by mass or less.
[14]A method of producing a beer-taste beverage containing adjusting an alcoholicity to 0.5 v/v % or more and 4.5 v/v % or less, and the content of heptanal to 0.1 ppb by mass or more and 3.8 ppb by mass or less.
[15]A method of inhibiting an immature odor in a beer-taste beverage containing adjusting an alcoholicity to 0.5 v/v % or more and 4.5 v/v % or less, and the content of heptanal to 0.1 ppb by mass or more and 3.8 ppb by mass or less.

### Effects of the Invention

According to the first embodiment of the present invention, a beer-taste beverage having a fresh aftertaste can be provided.

According to the second embodiment of the present invention, a beer-taste beverage having an inhibited wort odor can be provided.

According to the third embodiment of the present invention, a beer-taste beverage having an inhibited cheese-like smell can be provided.

According to the fourth embodiment of the present invention, a beer-taste beverage having an inhibited honey-like smell can be provided.

According to the fifth embodiment of the present invention, a beer-taste beverage having an inhibited immature odor can be provided.

### MODES FOR CARRYING OUT THE INVENTION

### First Embodiment

As a result of intensively studying the problems of freshness of an aftertaste mentioned above, the inventors of the present invention have newly found that the problem of freshness of the aftertaste can be solved in a case where a certain amount of isobutyraldehyde is contained in a beer-taste beverage having an alcoholicity of 0.5 v/v % or more and 4.5 v/v % or less. Although this mechanism is not clear, it is thought that an aroma of isobutyraldehyde is likely to stand out in a balance among various aroma ingredients in a case where an alcohol concentration is as low as 4.5 v/v % or less.

The “beer-taste beverage” as used herein refers to an alcoholic or non-alcoholic carbonated beverage having a beer-like flavor. In other words, the beer-taste beverage of the present specification embraces all the carbonated beverages having a beer flavor, unless specified otherwise. In the present specification, the “beer-taste alcoholic beverage” is a beer-taste beverage having an alcoholicity of 1 v/v % or more, and the “non-alcoholic beer-taste beverage” is a beer-taste beverage having an alcoholicity of less than 1 v/v %. The beer-taste beverage of the present invention may be a fermented beer-taste beverage which goes through a fermentation process using a yeast, and may also be a non-fermented beer-taste beverage which does not go through a fermentation process. The fermented beer-taste beverage may be a top-fermented beer-taste beverage which has been brewed through a fermentation process using a top-fermenting yeast, and also may be a bottom-fermented beer-taste beverage which has been brewed through a fermentation process using a bottom-fermenting yeast. In fermentation, a yeast (Saccharomyces) or a wild yeast (such as Brettanonyces) generating alcohol may be used, and also a yeast (such as Saccharomyces) or a wild yeast (such as Brettanonyces) not producing alcohol or a bacteria carrying out a lactic acid fermentation or a gluconic acid fermentation may be used. In a case of a fermented non-alcoholic beer-taste beverage, the non-alcoholic beer-taste beverage may be produced by a method in which a yeast is added and fermentation is stopped so as to have an alcoholicity of less than 1 v/v %, or a method in which a fermentation is carried out to have an alcoholicity of 1 v/v % or more and the fermented product is subjected to a dealcoholization step to have an alcoholicity of less than 1 v/v %. The non-alcoholic beer-taste beverage may be produced by mixing a non-fermented beer-taste beverage, the above-mentioned fermented non-alcoholic beer-taste beverage having alcoholicity of less than 1 v/v % obtained by stopping fermentation, or non-alcoholic beer-taste beverage obtained by subjecting to a dealcoholization step.

The alcoholicity (alcohol content) of the beer-taste beverage of the present invention is 0.5 v/v % or more and 4.5 v/v % or less, and can be, for example, 4.0 v/v % or less, 3.9 v/v % or less, 3.8 v/v % or less, 3.7 v/v % or less, 3.6 v/v % or less, 3.5 v/v % or less, 3.4 v/v % or less, 3.3 v/v % or less, 3.2 v/v % or less, 3.1 v/v % or less, 3.0 v/v %0 or less, 2.9 v/v % or less, 2.8 v/v % or less, 2.7 v/v % or less or the like. The lower limit can be, for example, 0.6 v/v % or more, 0.7 v/v % or more, 0.8 v/v % or more, 0.9 v/v % or more, 1.0 v/v % or more, 1.1 v/v % or more, 1.2 v/v % or more, 1.3 v/v % or more, 1.4 v/v % or more, 1.5 v/v % or more, 1.6 v/v % or more, 1.7 v/v % or more, 1.8 v/v % or more, 1.9 v/v % or more, 2.0 v/v % or more or the like. In the present specification, the alcoholicity (alcohol content) is measured according to a method described in the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the alcoholicity can be carried out by appropriately setting addition of diluting water or carbonated water, sugar composition of pre-fermented liquid, kinds of yeasts, an amount of yeasts, addition of brewed alcohol, addition of diluted alcohol, or the like. In addition, the alcoholicity can be adjusted by mixing with a content liquid in which an alcohol is reduced or completely removed from the beer-taste beverage by various methods such as distillation under reduced pressure.

The content of isobutyraldehyde in the beer-taste beverage of the present invention is 13.0 ppb by mass or less from a viewpoint of making the aftertaste fresh, and preferably 12.5 ppb by mass or less, more preferably 12.0 ppb by mass, even more preferably 11.5 ppb by mass or less, even more preferably 10.0 ppb by mass or less, even more preferably 9.5 ppb by mass or less, even more preferably 9.0 ppb by mass or less, even more preferably 8.5 ppb by mass or less and even more preferably 8.0 ppb by mass or less. The lower limit is 0.1 ppb by mass or more, and can be, for example, 0.2 ppb by mass or more, 0.3 ppb by mass or more, 0.4 ppb by mass or more, 0.5 ppb by mass or more, 1.0 ppb by mass or more, 1.5 ppb by mass or more, 2.0 ppb by mass or more, 2.5 ppb by mass or more, 3.0 ppb by mass or more, 3.5 ppb by mass or more, 4.0 ppb by mass or more, 4.5 ppb by mass or more, and the like. In the present specification, the content of isobutyraldehyde is analyzed according to the analysis method described in “Determination of Formaldehyde in Beer” (Miyakawa et al., Tokyo Metropolitan Institute of Public Health, Annual Report, volume 58, Supplement, 2007). The content of isobutyraldehyde can be adjusted by controlling use ratio of a malt in a wort-producing process, yeast strains used in a fermentation process, fermentation temperature, time subjected to fermentation, and the like.

From a viewpoint of giving a body, a real extract (R-Ex) concentration of the beer-taste beverage of the present invention is preferably 1.5 w/w % or more, more preferably 1.6 w/w % or more, even more preferably 1.7 w/w % or more, even more preferably 1.8 w/w % or more, even more preferably 2.0 w/w % or more, even more preferably 2.2 w/w % or more, even more preferably 2.5 w/w % or more, and even more preferably 3.0 w/w % or more. The upper limit can be, for example, 15.0 w/w % or less, 14.0 w/w % or less, 13.0 w/w % or less, 12.0 w/w % or less, 11.0 w/w % or less, 10.0 w/w % or less, 9.0 w/w % or less, 8.5 w/w % or less, 8.0 w/w % or less or the like. In the present specification, the real extract (R-Ex) concentration is measured according to the method described in the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The real extract (R-Ex) concentration can be adjusted by controlling a limit attenuation during a production of wort, or an apparent attenuation at a fermentation process. Alternatively, the real extract (R-Ex) concentration can be adjusted by optionally adding an extract ingredient. The extract ingredient may be an unfermented wort or a saccharified mash (moromi) after fermentation, or a beer-taste beverage which is treated with alcohol reduction/removal procedure and also may be adjusted by adding a liquid sugar, a powder sugar, a dietary fiber or the like.

The proline content in the beer-taste beverage of the present invention is, from a viewpoint of producing a beer-taste beverage in which at least one of a rich taste derived from wheat, a body, a thickness of taste and a complexity of taste is improved, preferably 10 mg/l or more, and the proline content is more preferably 30 mg/L or more, even more preferably 50 mg/L or more, even more preferably 70 mg/L or more and even more preferably 100 mg/L or more. Also, the proline content may be 110 mg/L or more, 120 mg/L or more, 130 mg/L or more, 140 mg/L or more, 150 mg/L or more, 160 mg/L or more, 170 mg/L or more, 180 mg/L or more, 190 mg/L or more, or 200 mg/L or more. On the other hand, from a viewpoint of producing a beer-taste beverage which is less likely to give a feeling of full, the proline content of the beer-taste beverage in one embodiment of the present invention is preferably 800 mg/L or less, more preferably 750 mg/L or less, even more preferably 700 mg/L or less, even more preferably 650 mg/L or less, even more preferably 600 mg/L or less, even more preferably 550 mg/L or less, even more preferably 500 mg/L or less, even more preferably 450 mg/L or less and even more preferably 400 mg/L or less, and also the proline content may be 350 mg/L or less, 300 mg/L or less, 250 mg/L or less or 200 mg/L or less. In the present specification, the proline content is measured using Amino Acid Analyzer L-8800A manufactured by Hitachi, Ltd., and the like.

The original wort extract (0-Ex) concentration in the beer-taste beverage of the present invention can be preferably 14.0 w/w % or less, more preferably 13.5 w/w % or less, even more preferably 13.0 w/w % or less, even more preferably 12.5 w/w % or less, even more preferably 12.0 w/w % or less, even more preferably 11.5 w/w % or less, even more preferably 11.0 w/w % or less, even more preferably 10.5 w/w % or less, even more preferably 10.0 w/w % or less, even more preferably 9.5 w/w % or less and even more preferably 9.0 w/w % or less. In addition, the O-Ex concentration is preferably 2.8 w/w % or more, more preferably 3.0 w/w % or more, even more preferably 3.5 w/w % or more, even more preferably 4.0 w/w % or more, even more preferably 4.5 w/w % or more, even more preferably 5.0 w/w % or more, even more preferably 5.5 w/w % or more, even more preferably 6.0 w/w % or more, even more preferably 6.5 w/w % or more and even more preferably 7.0 w/w % or more. In the present specification, the original wort extract (O-Ex) concentration is measured according to the method described in the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the original wort extract (0-Ex) concentration can be carried out by appropriately setting the addition of diluting water or carbonated water, kinds of raw materials (a malt, corn grits, a liquid sugar or the like), an amount of raw materials, the filtration time of wort, pH of a wort filtrate, boiling time, boiling temperature or the like.

The limit apparent attenuation (LA) in the beer-taste beverage of the present invention can be 80% or less, 75% or less, 70% or less, 69% or less, 68% or less, 67% or less, 66% or less, 65% or less, 64% or less, 63% or less, 62% or less, 61% or less, 60% or less, 58% or less, 56% or less, 54% or less, 53% or less or 52% or less. In addition, LA can be 16% or more, 18% or more, 20% or more, 22% or more, 23% or more, 24% or more, 26% or more, 28% or more, 30% or more, 31% or more, 32% or more, 33% or more, 34% or more, 35% or more, 36% or more, 37% or more, 38% or more, 39% or more, 40% or more, 42% or more, 44% or more or 46% or more. In the present specification, the limit apparent attenuation (LA) is measured by the method described in the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the limit apparent attenuation (LA) can be carried out by appropriately setting kinds of raw materials (a malt, corn grits, a liquid sugar or the like), an amount of raw materials, kinds of enzymes, an added amount of enzymes (including glycolysis enzyme, isomerization enzyme and the like), a timing of addition of enzymes, a saccharification time, pH upon saccharification, pH at a mashing process (a process for producing a wort from supplying malts and before addition of yeast), time of filtration of wort, setting temperature and maintaining time of each temperature region upon producing a wort (including the time of saccharification), and the like.

The apparent attenuation (AA %) in the beer-taste beverage of the present invention can be 80% or less, 75% or less, 70% or less, 69% or less, 68% or less, 67% or less, 66% or less, 65% or less, 64% or less, 63% or less, 62% or less, 61% or less, 60% or less, 58% or less, 56% or less, 54% or less, 53% or less or 52% or less. In addition, the AA % can be 16% or more, 18% or more, 20% or more, 22% or more, 23% or more, 24% or more, 26% or more, 28% or more, 30% or more, 31% or more, 32% or more, 33% or more, 34% or more, 35% or more, 36% or more, 37% or more, 38% or more, 39% or more, 40% or more, 42% or more, 44% or more or 46% or more. In the present specification, the limit apparent attenuation (LA) is measured according to the method described in the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the apparent attenuation (AA) can be appropriately carried out by controlling fermentation temperature at a time when the targeted apparent attenuation is achieved, or the like.

The pH in the beer-taste beverage of the present invention may be 2.5 or more, 2.6 or more, 2.7 or more, 2.8 or more, 2.9 or more, 3 or more, 3.1 or more, 3.2 or more or 3.3 or more. The pH may be 4.5 or less, 4.4 or less, 4.3 or less, 4.2 or less, 4.1 or less, 4.0 or less, 3.9 or less, 3.8 or less, 3.7 or less, 3.6 or less, 3.5 or less, 3.4 or less or 3.3 or less. The adjustment of pH can be carried out by appropriately setting an added amount of acetic acid or lactic acid, an added amount of diluting water or carbonated water, or the like. Further, the adjustment of pH can be carried out by appropriately setting kinds of raw materials (malts, corn grits, liquid sugar and the like), an amount of raw materials, kinds of enzymes, an added amount of enzymes, a timing of addition of enzymes, saccharification time in a mash tank, proteolysis time in a mash tank, pH in a mash tank, pH in the mashing process (a process for producing a wort from supplying malts and before addition of yeast), kinds of acid used upon adjusting pH (acetic acid, lactic acid, phosphoric acid, malic acid, tartaric acid, citric acid or the like), an added amount of acid used upon adjusting pH, timing of adjusting pH (at a time of mashing, at a time of fermentation, at a time of completion of fermentation, before filtration of beer, after filtration of beer, or the like), setting temperature and maintaining time of each temperature region upon producing a wort (including a time of saccharification), a concentration of original extract of pre-fermentation liquid, a concentration of original extract at a fermentation process, fermentation condition (oxygen concentration, ventilation condition, species of yeasts, an added amount of yeasts, the number of yeasts which proliferated, timing of removal of yeasts, fermentation temperature, fermentation time, setting of pressure, carbon dioxide concentration, or the like), or the like. In the present specification, the pH of the beer-taste beverage is measured according to the method described in section 8.7 pH of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013).

The chromaticity in the beer-taste beverage of the present invention may be, for example, 5 EBC or more, 10 EBC or more, 15 EBC or more, 20 EBC or more, 25 EBC or more, 30 EBC or more, 35 EBC or more, 40 EBC or more, 45 EBC or more, 50 EBC or more, 55 EBC or more, 60 EBC or more, 65 EBC or more, 70 EBC or more, 75 EBC or more, 80 EBC or more, 85 EBC or more, 90 EBC or more, 95 EBC or more or 100 EBC or more, and the chromaticity may be 120 EBC or less, 1.15 EBC or less, 110 EBC or less, 105 EBC or less, 100 EBC or less, 95 EBC or less, 90 EBC or less, 85 EBC or less or 80 EBC or less. In the present specification, chromaticity is measured according to the method described in Section 8.8 Chromaticity of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of chromaticity can be carried out by appropriately setting addition of diluting water or carbonated water, kinds of raw materials (malts, corn grits, liquid sugar and the like), an amount of raw materials, temperature at a time of mashing, pH at a time of mashing, time of mashing, time of filtration of wort, pH of a wort filtrate, boiling time, boiling temperature, an amount of coloring ingredients such as caramel pigment, manner of filtration of beer (diatomite filtration, various membrane filtration, or the like), a filtrated amount of filtration of beer, or the like.

The bitterness unit in the beer-taste beverage of the present invention may be, for example, 0.5 BUs or more, 1 BUs or more, 1.5 BUs or more, 2 BUs or more, 2.5 BUs or more, 3 BUs or more, 3.5 BUs or more, 4 BUs or more, 4.5 BUs or more, 5 BUs or more or 5.5 BUs or more, and also the bitterness unit may be 80 BUs or less, 70 BUs or less, 60 BUs or less, 50 BUs or less or 40 BUs or less. In the present specification, the bitterness unit is measured according to the method described in “Section 8.15 Bitterness Unit of BCOJ Beer Analysis Method (revised on Nov. 1, 2004).” Specifically, an acid is added to a degassed sample before extraction with isooctane, an absorbance of the obtained isooctane layer is measured at 275 nm using isooctane as a control, and the absorbance is multiplied by a factor, thereby being able to obtain a bitterness unit (BU). The bitterness unit depends on the content of iso-α acid contained in a beverage. An iso-α acid is obtained by isomerizing a acid contained in a hop. The amount of the iso-α acid can be controlled by species of hops, a used amount of hop, a timing of addition of a hop, temperature at an addition of a hop and maintaining time at the temperature zone, pH at a time of addition of a hop, a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like, the condition of filtration of beer, addition of diluting water, addition of carbonated water, or the like. In addition, the bitterness unit can be adjusted by a commercially available hop-processed product (iso-α acid or the like) or the like, and the bitterness unit can be adjusted by amount, kinds or timing of addition of the hop-processed product, temperature at the time of addition and maintaining time at the temperature zone, pH at the time of addition, a concentration of an original extract of pre-fermentation liquid, a concentration of an original extract at the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like), or the like, the condition of filtration of beer, addition of diluting water, addition of carbonated water, or the like. A pellet hop in which a hop is pelleted, a hop extract in which a hop is extracted, or a hop bract may be used as a hop. The hop or hop-processed product may be used alone or in combination.

The total nitrogen amount in the beer-taste beverage of the present invention may be, for example, 100 mg/L or more, 150 mg/L or more, 200 mg/L or more, 250 mg/L or more, 300 mg/L or more, 350 mg/L or more, 400 mg/L or more, 450 mg/L or more, 500 mg/L or more, 550 mg/L or more or 600 mg/L or more, and may be 2,000 mg/L or less, 1,800 mg/L or less, 1,600 mg/L or less, 1,400 mg/L or less, 1,200 mg/L or less, 1,150 mg/L or less, 1,100 mg/L or less, 1,050 mg/L or less, 1,000 mg/L or less, 950 mg/L or less, 900 mg/L or less, 850 mg/L or less, 800 mg/L or less or 750 mg/L or less. The total nitrogen amount is a total amount of all nitrogen compounds such as proteins or amino acids. In the present specification, the total nitrogen amount is measured according to the method described in Section 8.9 Total Nitrogen of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of total nitrogen amount can be carried out by appropriately setting a condition of filtration of beer such as addition of diluting water or carbonated water, kinds of raw materials (malts, corn grits, liquid sugar and the like), an amount of raw materials, kinds of enzymes, an added amount of enzymes (including proteolysis enzyme and the like), temperature upon enzymatic reaction, timing of the addition of enzymes, proteolysis time in a mash tank, pH in a mash tank, temperature in a mash tank, pH in the mashing process (a process for producing a wort from supplying malts and before addition of yeast), temperature at the mashing process, temperature upon filtration of wort, time of filtration of wort, pH at the time of filtration of a wort, an amount of sparging water used upon filtration of a wort, setting temperature and maintaining time of each temperature region upon producing a wort, boiling time and pH at boiling process, a concentration of an original extract of pre-fermentation liquid, a concentration of an original extract at the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like).

The total polyphenol amount in the beer-taste beverage of the present invention can be, for example, 20 mg/L or more, 40 mg/L or more, 50 mg/L or more, 60 mg/L or more, 80 mg/L or more, 100 mg/L or more, 120 mg/L or more, 140 mg/L or more, 160 mg/L or more, 180 mg/L or more or 200 mg/L or more, and 400 mg/L or less, 380 mg/L. or less, 360 mg/L or less, 340 mg/La or less, 320 mg/L or less, 300 mg/L or less, 280 mg/L or less, 260 mg/L or less, 240 mg/L or less or 220 mg/L or less. In the present specification, the total polyphenol amount is measured according to the method described in Section 8.19 Total Polyphenol of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the total polyphenol amount can be carried out by appropriately setting addition of diluting water or carbonated water, kinds of raw materials (raw materials containing polyphenol such as a malt), an amount of raw materials, kinds of enzymes, an added amount of enzymes, timing of addition of enzymes, pH in a mash tank, pH in the mashing process (a process for producing a wort from supplying malts and before addition of yeast), time of filtration of a wort, setting temperature and maintaining time of each temperature region upon producing a wort (including a time of saccharification), a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like. In addition, the total polyphenol amount of the beer-taste beverage of the present invention can be controlled by adjusting, for example, a used amount of raw materials having a large polyphenol content such as a barley malt or a husk (hull) of a malt. Specifically, the total polyphenol amount can be increased by increasing a used amount of raw materials having a large polyphenol content such as a malt.

The content of free amino nitrogen (FAN) in the beer-taste beverage of the present invention can be 10 mg/L or more, 20 mg/L or more, 30 mg/L or more, 40 mg/L or more, 50 mg/L or more, 60 mg/L or more, 70 mg/L or more, 80 mg/L or more, 90 mg/L or more or 100 mg/L or more, and the content of FAN can be 200 mg/L or less, 190 mg/L or less, 180 mg/L or less, 170 mg/L or less, 160 mg/L or less, 150 mg/L or less or 140 mg/L or less. In the present specification, the content of FAN is measured by the method described in Section 8.1 Free Amino Nitrogen of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The adjustment of the content of FAN can be carried out by appropriately setting addition of diluting water or carbonated water, kinds of raw materials (malts, corn grits, liquid sugar and the like), an amount of raw materials, kinds of enzymes, an added amount of enzymes (including proteolysis enzyme or the like), timing of addition of enzymes, proteolysis time in a mash tank, pH in a mash tank, pH in the mashing process (a process for producing a wort from supplying malts and before addition of yeast), time of filtration of a wort, setting temperature and maintaining time of each temperature region upon producing a wort, boiling time and pH in the boiling process, a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

The content of iso-α acid in the beer-taste beverage of the present invention is preferably 5.0 ppm by mass or more, more preferably 6.0 ppm by mass or more, even more preferably 7.0 ppm by mass or more and even more preferably 8.0 ppm by mass or more, from a viewpoint of the beer-like aroma, and also preferably 80 ppm by mass or less, more preferably 70 ppm by mass or less and even more preferably 60 ppm by mass or less, from the same viewpoint. In the present specification, the content of iso-α acid is measured according to the method described in Section 8.25 Iso-α Acid, a Acid of the revised BCOJ Beer Analysis Method (issued by Public Interest Incorporated Foundation, Brewing Society of Japan, edited by Brewers Association of Japan, Brewery Convention of Japan [Analysis Committee], revised and supplemented in 2013). The content of iso-α acid can be adjusted by species of hops, a used amount of a hop, a timing of addition of a hop, the temperature upon addition of a hop and maintaining time at the temperature zone, pH upon addition of a hop, a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like, a condition of filtration of beer, addition of diluting water, addition of carbonated water, or the like. In addition, the content of iso-α acid can be adjusted by a commercially available hop-processed product (iso-α acid or the like) or the like, and the content of iso-α acid can be adjusted by amount, kinds or timing of addition of the hop-processed product, temperature upon addition and maintaining time at the temperature zone, pH at the time of addition, a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like, the condition of filtration of beer, addition of diluting water, addition of carbonated water, or the like. A pellet hop in which a hop is pelleted, a hop extract in which a hop is extracted by a supercritical carbon dioxide gas or the like, or a hop bract may be used as a hop. The hop and hop-processed product may be used alone or in combination.

The beer-taste beverage of the present invention preferably contains ethyl acetate. The content of ethyl acetate can be 0.1 ppm by mass or more, 0.2 ppm by mass or more, 0.3 ppm by mass or more, 0.4 ppm by mass or more, 0.5 ppm by mass or more, 0.6 ppm by mass or more, 0.7 ppm by mass or more, 0.8 ppm by mass or more, 0.9 ppm by mass or more, 1.0 ppm by mass or more, 2.0 ppm by mass or more, 3.0 ppm by mass or more, 4.0 ppm by mass or more, 5.0 ppm by mass or more, 6.0 ppm by mass or more, 7.0 ppm by mass or more, 8.0 ppm by mass or more, 9.0 ppm by mass or more, 10.0 ppm by mass or more, 11.0 ppm by mass or more, 12.0 ppm by mass or more, 13.0 ppm by mass or more, 14.0 ppm by mass or more or 15.0 ppm by mass or more, and also the content of ethyl acetate can be 60.0 ppm by mass or less, 50.0 ppm by mass or less, 45.0 ppm by mass or less or 40.0 ppm by mass or less. In the present specification, the content of ethyl acetate is measured by a gas chromatography. The adjustment of the content of ethyl acetate can be carried out by appropriately setting addition of diluting water or carbonated water, addition of ethyl acetate-containing flavor, an amount of ethyl acetate-containing flavor, an amount of ethyl acetate-containing raw materials, addition of ethyl acetate-containing raw materials, kinds of raw materials containing ethyl acetate, an amount of a substrate of ethyl acetate, an amount of raw materials which are a substrate of ethyl acetate, an amount of raw materials, kinds of raw materials, kinds of enzymes, an added amount of enzymes, timing of addition of enzymes, saccharification time in a mash tank, proteolysis time in a mash tank, pH in a mash tank, pH in the mashing process (a process for producing a wort from supplying malts and before addition of yeast), an added amount of acid used upon adjusting pH, timing of adjusting pH (at a time of mashing, at a time of fermentation, at a time of completion of fermentation, before filtration of beer, after filtration of beer, or the like), setting temperature and maintaining time of each temperature region upon producing a wort (including a time of saccharification), a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

The content of isoamyl acetate in the beer-taste beverage of the present invention can be, for example, 1 ppm by mass or more, 2 ppm by mass or more, 3 ppm by mass or more, 4 ppm by mass or more, 5 ppm by mass or more, 7 ppm by mass or more, 9 ppm by mass or more, 10 ppm by mass or more, 20 ppm by mass or more, 30 ppm by mass or more, 40 ppm by mass or more, 50 ppm by mass or more, 60 ppm by mass or more, 70 ppm by mass or more, 80 ppm by mass or more, 90 ppm by mass or more or 100 ppm by mass or more, and can be 200 ppm by mass or less, 190 ppm by mass or less, 180 ppm by mass or less, 170 ppm by mass or less, 160 ppm by mass or less, 150 ppm by mass or less, 140 ppm by mass or less, 130 ppm by mass or less, 120 ppm by mass or less or 110 ppm by mass or less. In the present specification, the content of isoamyl acetate is measured by a gas chromatography. The adjustment of the content of isoamyl acetate can be carried out by appropriately setting addition of diluting water or carbonated water, addition of isoamyl acetate-containing flavor, an amount of isoamyl acetate-containing flavor, an amount of isoamyl acetate-containing raw materials, addition of isoamyl acetate-containing raw materials, kinds of raw materials containing isoamyl acetate, an amount of a substrate of isoamyl acetate, an amount of raw materials which are a substrate of isoamyl acetate, an amount of raw materials, kinds of raw materials, kinds of enzymes, an added amount of enzymes, the timing of addition of enzymes, saccharification time in a mash tank, proteolysis time in a mash tank, pH in a mash tank, pH in the mashing process (a process for producing a wort from supplying malts and before addition of yeast), an added amount of acid used upon adjusting pH, timing of adjusting pH (at a time of mashing, at a time of fermentation, at a time of completion of fermentation, before filtration of beer, after filtration of beer, or the like), setting temperature and maintaining time of each temperature region upon producing a wort (including a time of saccharification), a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

The content of isoamyl alcohol in the beer-taste beverage of the present invention can be 1.0 ppm by mass or more, 2.0 ppm by mass or more, 3.0 ppm by mass or more, 4.0 ppm by mass or more, 5.0 ppm by mass or more, 6.0 ppm by mass or more, 7.0 ppm by mass or more, 8.0 ppm by mass or more, 9.0 ppm by mass or more, 10.0 ppm by mass or more, 15.0 ppm by mass or more, 20.0 ppm by mass or more or 30.0 ppm by mass or more, and also the content of isoamyl alcohol can be 100.0 ppm by mass or less, 90.0 ppm by mass or less, 80.0 ppm by mass or less, 70.0 ppm by mass or less, 60.0 ppm by mass or less, 50.0 ppm by mass or less or 40.0 ppm by mass or less. In the present specification, the content of isoamyl alcohol is measured by a gas chromatography. The adjustment of the content of isoamyl alcohol can be carried out by appropriately setting addition of diluting water or carbonated water, addition of isoamyl alcohol-containing flavor, an amount of isoamyl alcohol-containing flavor, an amount of isoamyl alcohol-containing raw materials, addition of isoamyl alcohol-containing raw materials, kinds of raw materials containing isoamyl alcohol, an amount of a substrate of isoamyl alcohol, an amount of raw materials which are a substrate of isoamyl alcohol, an amount of raw materials, kinds of raw materials, kinds of enzymes, an added amount of enzymes, the timing of addition of enzymes, saccharification time in a mash tank, proteolysis time in a mash tank, pH in a mash tank, pH in the mashing process (a process for producing a wort from supplying malts and before addition of yeast), an added amount of acid used upon adjusting pH, timing of adjusting pH (at a time of mashing, at a time of fermentation, at a time of completion of fermentation, before filtration of beer, after filtration of beer, or the like), setting temperature and maintaining time of each temperature region upon producing a wort (including a time of saccharification), a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

The content of ethyl caproate in the beer-taste beverage of the present invention can be 1.0 ppb by mass or more, 2.0 ppb by mass or more, 3.0 ppb by mass or more, 4.0 ppb by mass or more, 5.0 ppb by mass or more, 6.0 ppb by mass or more, 7.0 ppb by mass or more, 8.0 ppb by mass or more, 9.0 ppb by mass or more, 10.0 ppb by mass or more, 15.0 ppb by mass or more, 20.0 ppb by mass or more, 25.0 ppb by mass or more, 30.0 ppb by mass or more, 35.0 ppb by mass or more, 40.0 ppb by mass or more, 45.0 ppb by mass or more or 50.0 ppb by mass or more, and also the content of ethyl caproate can be 900.0 ppb by mass or less, 800.0 ppb by mass or less, 700.0 ppb by mass or less, 650.0 ppb by mass or less, 600.0 ppb by mass or less, 550.0 ppb by mass or less, 500.0 ppb by mass or less, 450.0 ppb by mass or less or 400.0 ppb by mass or less. In the present specification, the content of ethyl caproate is measured by a gas chromatography. The adjustment of the content of ethyl caproate can be carried out by appropriately setting addition of diluting water or carbonated water, addition of ethyl caproate-containing flavor, an amount of ethyl caproate-containing flavor, an amount of ethyl caproate-containing raw materials, addition of ethyl caproate-containing raw materials, kinds of raw materials containing ethyl caproate, an amount of a substrate of ethyl caproate, an amount of raw materials which are a substrate of ethyl caproate, an amount of raw materials, kinds of raw materials, kinds of enzymes, an added amount of enzymes, the timing of addition of enzymes, saccharification time in a mash tank, proteolysis time in a mash tank, pH in a mash tank, pH in the mashing process (a process for producing a wort from supplying malts and before addition of yeast), an added amount of acid used upon adjusting pH, timing of adjusting pH (at a time of mashing, at a time of fermentation, at a time of completion of fermentation, before filtration of beer, after filtration of beer or the like), setting temperature and maintaining time of each temperature region upon producing a wort (including a time of saccharification), a concentration of an original extract of pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

The content of 4-vinyl guaiacol (4VG) in the beer-taste beverage of the present invention can be, for example, 1 μg/L or more, 50 μg/L or more, 100 μg/L or more, 150 μg/L or more, 200 μg/L or more, 250 μg/L or more, 300 μg/L or more or 350 μg/L or more, and 1,000 μg/L or less, 900 μg/L or less, 800 μg/L or less, 750 μg/L or less, 700 μg/L or less, 650 μg/L or less, 600 μg/L or less, 550 μg/L or less, 500 μg/L or less, 450 μg/L or less or 400 μg/L or less. In the present specification, the content of 4-vinyl guaiacol is measured by a gas chromatography. The adjustment of the content of 4-vinyl guaiacol can be carried out by appropriately setting addition of diluting water or carbonated water, addition of 4-vinyl guaiacol-containing flavor, an amount of 4-vinyl guaiacol-containing flavor, an amount of 4-vinyl guaiacol-containing raw materials, addition of 4-vinyl guaiacol-containing raw materials, kinds of raw materials containing 4-vinyl guaiacol, an amount of a substrate of 4-vinyl guaiacol (ferulic acid or the like), an amount of raw materials which are a substrate of 4-vinyl guaiacol (ferulic acid or the like), an amount of raw materials, kinds of raw materials, kinds of enzymes, an added amount of enzymes, the timing of addition of enzymes, saccharification time in a mash tank, proteolysis time in a mash tank, pH in a mash tank, pH in the mashing process (a process for producing a wort from supplying malts and before addition of yeast), an added amount of acid used upon adjusting pH, timing of adjusting pH (at a time of mashing, at a time of fermentation, at a time of completion of fermentation, before filtration of beer, after filtration of beer, or the like), setting temperature and maintaining time of each temperature region upon producing a wort (including a time of saccharification), a concentration of an original extract pre-fermentation liquid, a concentration of an original extract in the fermentation process, fermentation conditions (oxygen concentration, ventilation condition, species of yeasts, an added amount of yeasts, the number of yeasts which proliferated, timing of removal of yeasts, fermentation temperature, fermentation time, setting of pressure, carbon dioxide concentration, and the like) or the like.

As a main raw material in the beer-taste beverage of the present invention, a malt may be used together with water, and a malt may not be used. Further, a hop may be used, and besides, a preservative, a sweetener, a water-soluble dietary fiber, a bittering agent or a bitterness giving agent, an antioxidant, a flavor, an acidulant, salts, spirits, or the like may be used.

The malt refers to ones obtained by germinating, drying and root-removing the seeds of barley, wheat, rye, common wild oat, oat, Job's tears or Avena sativa, and the origin or variety thereof may not be limited, and a barley malt is preferable. The barley malt is one of malts most commonly used as a raw material of a beer-taste beverage in Japan. The barley has varieties such as two-row barley and six-row barley, and either of them may be used. Further, besides the normal malts, colored malts can be used. Incidentally, when the colored malts are used, colored malts in different varieties may be appropriately combined and used, or one kind of colored malt may be used.

In addition, grains other than malts, a protein, a yeast extract, a liquid sugar and the like may be used together with malts. The grains include, for example, barley, wheat, rye, common wild oat, oat, Job's tears, Avena sativa and the like, rice (white rice, brown rice and the like), maize (corn grits and the like), Sorghum bicolor (Kaoliang), potatoes, bean (soybean, green pea and the like), buckwheat, sorghum, foxtail millet, Japanese barnyard millet, and a starch obtained therefrom, an extract of the above, and the like. Among them, maize (corn grits and the like) is preferably used. In addition, the protein includes a soybean protein, a green pea protein, a yeast extract, a degraded product thereof, and the like.

Incidentally, when malts are not used, the beer-taste beverage includes a beer-taste beverage obtained by using a liquid sugar containing a carbon source, and a nitrogen source as an amino acid-containing material (for example, a soybean protein and the like) such as the grains mentioned above other than malts.

The hop includes, for example, a pellet hop, a powder hop, a hop extract and the like. In addition, a hop processed product such as an isomerized hop and a reduced hop may be used as a hop.

The preservative includes, for example, benzoic acid; benzoate such as sodium benzoate; benzoic acid ester such as paraoxy propyl benzoate or paraoxy butyl benzoate; dimethyl bicarbonate, and the like. In addition, as a preservative, a commercially available formulation such as Strong Sanpreser (manufactured by San-Ei Gen F. F. I. Inc., a mixture of sodium benzoate and butyl benzoate) may be used. These preservatives may be used alone, or used in combination of two or more kinds. The formulated amount of the preservative is preferably 5 ppm by mass or more and 1,200 ppm by mass or less, more preferably 10 ppm by mass or more and 1,100 ppm by mass or less, even more preferably 15 ppm by mass or more and 1,000 ppm by mass or less, and even more preferably 20 ppm by mass or more and 900 ppm by mass or less.

The sweetener includes a commercially available saccharified liquid in which a starch derived from a grain is degraded by an acid or an enzyme, a saccharide such as a commercially available starch syrup, a trisaccharide or more sugar, a sugar alcohol, a natural sweetener such as stevia, an artificial sweetener, and the like. The formation of these saccharides may be a liquid such as a solution or a solid such as a powder. In addition, the kinds of raw material grains of a starch, a purification method of a starch, and a treatment condition such as hydrolysis by an enzyme or an acid are not particularly limited. For example, a saccharide of which a ratio of maltose is enhanced may be used by appropriately setting a condition of hydrolysis by an enzyme or an acid. Besides them, sucrose, fructose, glucose, maltose, trehalose, maltotriose, a solution thereof (liquid sugar), and the like also can be used. An isomerized sugar such as isomaltose or isomaltotriose, and the like also can be used. In addition, the artificial sweetener includes, for example, aspartame, acesulfam sodium (acesulfam K), sucralose, neotame and the like. The sweetener may be used alone, or used in combination of two or more kinds.

The water-soluble dietary fiber includes, for example, indigestible dextrin, polydextrose, soybean dietary fiber, guar gum degraded product, pectin, glucomannan, alginic acid, laminarin, fucoidin, carrageenan, and the like, and indigestible dextrin and polydextrose are preferable from a viewpoint of versatility such as stability or safety.

The bittering agent or bitterness giving agent includes, without particularly limiting to, for example, rosemary, litchi, caraway, juniper berry, sage, meitetsukou, reishi mushroom, laurel, quassin, a citrus extract, a bitterwood extract, a coffee extract, a tea extract, a bitter gourd extract, a lotus germ extract, a krantz aloe extract, a rosemary extract, a litchi extract, a laurel extract, a sage extract, a caraway extract, naringin, absinthin, wormwood, wormwood extract, and the like, besides a hop.

The antioxidant is not particularly limited, and the antioxidant used in the usual beer or happoushu (low-malt beer) can be used, and the antioxidant includes, for example, ascorbic acid, erythorbic acid, tocopherols such as vitamin E, catechin, and the like.

The flavor is not particularly limited, and an usual beer flavor can be used. The beer flavor is used to give a beer-like flavor, and includes a brewed ingredient and the like generated by fermentation. The beer flavor includes a beer flavor (a flavor eliciting a beer-like aroma) containing esters, higher alcohols or lactones, for example, isoanyl acetate, n-propanol, isobutanol, acetaldehyde, ethyl caproate, ethyl caproate, isoamyl propionate, linalool, geraniol, citral, 4-vinyl guaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undeclactone, ethyl hexanoate, 2-methyl ethyl lactate, n-ethyl lactate, myrcene, and the like.

The acidulant is not particularly limited, as long as the acidulant is a substance having acidity, and the acidulant includes, for example, tartaric acid, phosphoric acid, citric acid, gluconic acid, lactic acid, malic acid, phytic acid, acetic acid, succinic acid, glucono-delta-lactone or a salt thereof. Among these acidulant, tartaric acid, phosphoric acid, citric acid, gluconic acid, lactic acid, malic acid, phytic acid, acetic acid, succinic acid or a salt thereof is preferable, and tartaric acid, phosphoric acid, citric acid, lactic acid, acetic acid or a salt thereof is more preferable. These acidulants may be used alone, or used in combination of two or more kinds.

In the present specification, the spirit means liquors obtained by using grains such as wheat, rice, buckwheat or maize as a raw material, saccharifying the grains using a malt or optionally enzymatic agent, fermenting the saccharified product with a yeast, and further distilling the fermented product. Wheat is preferable as the grains which are used as a raw material of a spirit.

One embodiment of the beer-taste beverage of the present invention includes an embodiment of a bottled beverage. The examples of a container include a glass bottle, a PET-bottle, a can or a barrel, and a can, a glass bottle and a PET-bottle are preferable from a viewpoint of being particularly easy to transport. Incidentally, when a colorless and transparent glass bottle or PET-bottle is used, contents therein become exposed to sunlight or a light of a fluorescent, so that a colored glass bottle, a colored PET-bottle, a can or a barrel is preferable.

The malt ratio of the beer-taste beverage of the present invention can be 20% or more, 25% or more, 30% or more, 35% or more, 40% or more, 42% or more, 45% or more or 50% or more, and also the malt ratio can be 100% or less, 90% or less, 80% or less, 75% or less, 70% or less, 65% or less, 60% or less, 55% or less or 52% or less. In the present specification, the malt ratio means a value calculated according to Interpretation Notices for Liquor Tax Law and Administrative Regulations Related to Alcoholic Beverages enforced on Apr. 1, 2016.

When corn grits are used for the beer-taste beverage of the present invention, a bulging taste matching to a beer-taste beverage can be enhanced. When corn grits are used, presence or absence of the usage can be confirmed from a display of raw materials, because corn, corn grits, maize or the like is displayed on a product.

The corn grits ratio of the beer-taste beverage of the present invention can be, for example, 0% or more, 5% or more, 7.5% or more, 10% or more, 12.5% or more, 15% or more, 17.5% or more or 20% or more, and 50% or less, 47.5% or less, 45% or less, 42.5% or less, 40% or less, 37.5% or less, 35% or less, 32.5% or less, 30% or less, 27.5% or less, 25% or less or 22.5% or less. In the present specification, the corn grits ratio means a value calculated according to Interpretation Notices for Liquor Tax Law and Administrative Regulations Related to Alcoholic Beverages enforced on Apr. 1, 2016.

When a liquid sugar is used in the present invention, the aftertaste of the beer-taste beverage can be made fresh. The liquid sugar refers to a sugar containing at least one or more kinds of glucose, fructose, maltose, isomaltose, maltotriose, isomaltotriose, maltotetraose, isomaltotetraose, and the liquid sugar may contain two or more kinds of them. From a viewpoint of easiness of handling in the process, a liquid sugar which is a liquid is preferable, but a sugar in a form of pulverized shape (such as powder), solid or the like may be used. When a sugar in a form of pulverized shape (such as powder), solid or the like is used, a sugar containing at least one or more kinds of glucose, fructose, maltose, isomaltose, maltotriose, isomaltotriose, maltotetraose, isomaltotetraose is also preferable, and two or more kinds of them may be used. When a liquid sugar is used, presence or absence of the usage can be confirmed from a display of raw materials, because a saccharide or the like is displayed on a product.

The liquid sugar ratio of the present invention can be, for example, 0% or more, 2% or more, 4% or more, 6% or more, 8% or more, 10% or more, 12% or more, 14% or more, 16% or more, 18% or more or 20% or more, and 50% or less, 48% or less, 46% or less, 44% or less, 42% or less, 40% or less, 38% or less, 36% or less, 34% or less, 32% or less, 30% or less, 28% or less, 26% or less, 24% or less or 22% or less. In the present specification, the liquid sugar ratio means a value calculated according to Interpretation Notices for Liquor Tax Law and Administrative Regulations Related to Alcoholic Beverages enforced on Apr. 1, 2016.

The amount of carbon dioxide gas in the beer-taste beverage of the present invention is presented by a carbon dioxide gas pressure of the beverage. Typically, the upper limit of the carbon dioxide gas pressure is 5.0 kg/cm², 4.5 kg/cm² or 4.0 kg/cm², and the lower limit is 0.20 kg/cm², 0.50 kg/cm² or 1.0 kg/cm², and any of these upper limits and the lower limits may be combined. For example, the carbon dioxide gas pressure of the beverage may be 020 kg/cm² or more and 5.0 kg/cm² or less, 0.50 kg/cm² or more and 4.5 kg/cm² or less, or 1.0 kg/cm² or more and 4.0 kg/cm² or less. In the present specification, the gas pressure refers to a gas pressure in a container, except for especial cases. The pressure is measured using a method including immobilizing a sample set to 20° C. in a gas internal pressure measuring device, opening a valve of the gas internal pressure measuring device once to degas, closing the valve again, and reading the value at the time when a needle reaches a constant position by shaking the gas internal pressure measuring device, or using a commercially available gas pressure measurement device.

The beer-taste beverage of the present invention may optionally contain various additives. The additive includes, for example, a colorant, a foaming agent, a fermentation promoting agent, a yeast extract, a protein-based substance such as a peptide-containing material, an amino acid (glycine, proline, or the like), and a seasoning such as amino acids.

The colorant is used to give a beer-like color to a beverage, and caramel pigment and the like can be used.

The foaming agent is used to form a beer-like foam in a beverage or to maintain a foam of a beverage, and a plant-extracted saponin-based substance such as soybean saponin or quillai saponin, a plant protein such as corn or soybean, a peptide-containing material such as collagen peptide, a yeast extract, and the like can be appropriately used.

The fermentation promoting agent is used to promote fermentation by yeast, and, for example, a yeast extract, a bran ingredient of rice, wheat or the like, vitamins, minerals, or the like can be used alone or in combination.

### Second Embodiment

As a result of intensively studying the problems of inhibiting a wort odor mentioned above, the inventors of the present invention have newly found that the problems of inhibiting a wort odor mentioned above can be solved in a beer-taste beverage having an alcoholicity of 0.5 v/v % or more and 4.5 v/v % or less in a case where 2-methylbutanal is in a certain amount. Although this mechanism is not clear, it is thought that an aroma of 2-methylbutanal is likely to stand out in a balance among various aroma ingredients in a case where an alcohol concentration is as low as 4.5 v/v % or less.

The content of 2-methylbutanal in the beer-taste beverage of the present invention is 2.8 ppb by mass or less from a viewpoint of inhibiting a wort odor, and preferably 2.7 ppb by mass or less, more preferably 2.6 ppb by mass, even more preferably 2.5 ppb by mass or less, even more preferably 2.4 ppb by mass or less, even more preferably 2.3 ppb by mass or less, even more preferably 2.2 ppb by mass or less, even more preferably 2.1 ppb by mass or less, and even more preferably 2.0 ppb by mass or less. The lower limit is 0.1 ppb by mass or more, and the lower limit can be, for example, 0.2 ppb by mass or more, 0.3 ppb by mass or more, 0.4 ppb by mass or more, 0.5 ppb by mass or more, 1.0 ppb by mass or more, 1.5 ppb by mass or more, 2.0 ppb by mass or more, 2.5 ppb by mass or more, 3.0 ppb by mass or more, or the like. In the present specification, the content of 2-methylbutanal is analyzed according to the analysis method described in “Determination of Formaldehyde in Beer” (Miyakawa et al., Tokyo Metropolitan Institute of Public Health, Annual Report, volume 58, Supplement, 2007). The adjustment of the content of 2-methylbutanal can be carried out by controlling use ratio of a malt in a process for producing a wort, strains of yeast used in the fermentation process, fermentation temperature, time to be subjected to fermentation, or the like. Incidentally, other components and the like are same as described in the first embodiment.

### Third Embodiment

As a result of intensively studying the problems of inhibiting a cheese-like smell mentioned above, the inventors of the present invention have newly found that the problems of inhibiting a cheese-like smell mentioned above can be solved in a beer-taste beverage having an alcoholicity of 0.5 v/v % or more and 4.5 v/v % or less in a case where 3-methylbutanal is in a certain amount. Although this mechanism is not clear, it is thought that an aroma of 3-methylbutanal is likely to stand out in a balance among various aroma ingredients in a case where an alcohol concentration is as low as 4.5 v/v % or less.

The content of 3-methylbutanal in the beer-taste beverage of the present invention is 8.0 ppb by mass or less from a viewpoint of inhibiting a cheese-like smell, and preferably 7.5 ppb by mass or less, more preferably 7.0 ppb by mass, even more preferably 6.5 ppb by mass or less, even more preferably 6.0 ppb by mass or less, even more preferably 5.5 ppb by mass or less, even more preferably 5.0 ppb by mass or less, even more preferably 4.5 ppb by mass or less and even more preferably 4.0 ppb by mass or less. The lower limit is 0.1 ppb by mass or more, and the lower limit can be, for example, 0.2 ppb by mass or more, 0.3 ppb by mass or more, 0.4 ppb by mass or more, 0.5 ppb by mass or more, 1.0 ppb by mass or more, 1.5 ppb by mass or more, 2/0 ppb by mass or more, 2.5 ppb by mass or more, 3.0 ppb by mass or more, or the like. In the present specification, the content of 3-methylbutanal is analyzed according to the analysis method described in “Determination of Formaldehyde in Beer” (Miyakawa et al., Tokyo Metropolitan Institute of Public Health, Annual Report, volume 58, Supplement, 2007). The adjustment of the content of 3-methylbutanal can be carried out by controlling use ratio of a malt in a process for producing a wort, strains of yeast used in the fermentation process, fermentation temperature, time to be subjected to fermentation, or the like. Incidentally, other components and the like are same as described in the first embodiment.

### Fourth Embodiment

As a result of intensively studying the problems of inhibiting a honey-like smell mentioned above, the inventors of the present invention have newly found that the problems of inhibiting a honey-like smell mentioned above can be solved in a beer-taste beverage having an alcoholicity of 0.5 v/v % or more and 4.5 v/v % or less in a case where phenylacetaldehyde is in a certain amount. Although this mechanism is not clear, it is thought that an aroma of phenylacetaldehyde is likely to stand out in a balance among various aroma ingredients in a case where an alcohol concentration is as low as 4.5 v/v % or less.

The content of phenylacetaldehyde in the beer-taste beverage of the present invention is 65.0 ppb by mass or less from a viewpoint of inhibiting a honey-like smell, and preferably 60.0 ppb by mass or less, more preferably 55.0 ppb by mass, even more preferably 50.0 ppb by mass or less, even more preferably 45.0 ppb by mass or less, even more preferably 40.0 ppb by mass or less, even more preferably 35.0 ppb by mass or less and even more preferably 30.0 ppb by mass or less. The lower limit is 0.1 ppb by mass or more, and the lower limit can be, for example, 0.2 ppb by mass or more, 0.3 ppb by mass or more, 0.4 ppb by mass or more, 0.5 ppb by mass or more, 1.0 ppb by mass or more, 1.5 ppb by mass or more, 2.0 ppb by mass or more, 2.5 ppb by mass or more, 3.0 ppb by mass or more, 3.5 ppb by mass or more, 4.0 ppb by mass or more, 4.5 ppb by mass or more, 5.0 ppb by mass or more, 5.5 ppb by mass or more, 6.0 ppb by mass or more, 6.5 ppb by mass or more, 7.0 ppb by mass or more, 7.5 ppb by mass or more, 8.0 ppb by mass or more, 8.5 ppb by mass or more, 9.0 ppb by mass or more, 9.5 ppb by mass or more, 10.0 ppb by mass or more, 11.0 ppb by mass or more, 12.0 ppb by mass or more, 13.0 ppb by mass or more, 14.0 ppb by mass or more, 15.0 ppb by mass or more, or the like. In the present specification, the content of phenylacetaldehyde is analyzed according to the analysis method described in “Determination of Formaldehyde in Beer” (Miyakawa et al., Tokyo Metropolitan Institute of Public Health, Annual Report, volume 58, Supplement, 2007). The adjustment of the content of phenylacetaldehyde can be carried out by controlling use ratio of a malt in a process for producing a wort, strains of yeast used in the fermentation process, fermentation temperature, time to be subjected to fermentation, or the like. Incidentally, other components and the like are same as described in the first embodiment.

### Fifth Embodiment

As a result of intensively studying the problems of inhibiting an immature odor mentioned above, the inventors of the present invention have newly found that the problems of inhibiting an immature odor mentioned above can be solved in a beer-taste beverage having an alcoholicity of 0.5 v/v % or more and 4.5 v/v % or less in a case where heptanal is in a certain amount. Although this mechanism is not clear, it is thought that an aroma of heptanal is likely to stand out in a balance between various aroma ingredients in a case where an alcohol concentration is as low as 4.5 v/v % or less.

The content of heptanal in the beer-taste beverage of the present invention is 3.8 ppb by mass or less from a viewpoint of inhibiting an immature odor, and preferably 3.7 ppb by mass or less, more preferably 3.6 ppb by mass, even more preferably 3.5 ppb by mass or less, even more preferably 3.4 ppb by mass or less, even more preferably 3.3 ppb by mass or less, even more preferably 3.2 ppb by mass or less, even more preferably 3.1 ppb by mass or less and even more preferably 3.0 ppb by mass or less. The lower limit is 0.1 ppb by mass or more, and the lower limit can be, for example, 0.2 ppb by mass or more, 0.3 ppb by mass or more, 0.4 ppb by mass or more, 0.5 ppb by mass or more, 1.0 ppb by mass or more, 1.5 ppb by mass or more, 2.0 ppb by mass or more, or the like. In the present specification, the content of heptanal is analyzed according to the analysis method described in “Determination of Formaldehyde in Beer” (Miyakawa et al., Tokyo Metropolitan Institute of Public Health, Annual Report, volume 58, Supplement, 2007). The adjustment of the content of heptanal can be carried out by controlling use ratio of a malt in a process for producing a wort, strains of yeasts used in the fermentation process, fermentation temperature, time to be subjected to fermentation, or the like. Incidentally, other components and the like are same as described in the first embodiment.

### (Production Method of Beer-Taste Beverage)

The beer-taste beverage of the first embodiment of the present invention can be produced in a similar method to those of a general beer-taste beverage, except that the method includes adjusting an alcoholicity to 0.5 v/v % or more and 4.5 v/v % or less, and the content of isobutyraldehyde to 0.1 ppb by mass or more and 13 ppb by mass or less. Hereinafter, as a method of producing a general beer-taste beverage, production methods with or without using a malt as a raw material are shown. Incidentally, the step of adjusting alcoholicity to 0.5 v/v % or more and 4.5 v/v % or less, and the content of isobutyraldehyde to 0.1 ppb by mass or more and 13 ppb by mass or less can be controlled by the various methods mentioned above. In addition, adjustment of an alcoholicity and the content of isobutyraldehyde may be carried out simultaneously or separately.

The beer-taste beverage of the second embodiment of the present invention can be produced in a similar method to those of a general beer-taste beverage, except that the method includes adjusting an alcoholicity to 0.5 v/v % or more and 4.5 v/v % or less, and the content of 2-methylbutanal to 0.1 ppb by mass or more and 2.8 ppb by mass or less. Hereinafter, as a method of producing a general beer-taste beverage, production methods with or without using a malt as a raw material are shown. Incidentally, the step of adjusting an alcoholicity to 0.5 v/v % or more and 4.5 v/v % or less, and the content of 2-methylbutanal to 0.1 ppb by mass or more and 2.8 ppb by mass or less can be controlled by the various methods mentioned above. In addition, adjustment of an alcoholicity and the content of 2-methylbutanal may be carried out simultaneously or separately.

The beer-taste beverage of the third embodiment of the present invention can be produced in a similar method to those of a general beer-taste beverage, except that the method includes adjusting an alcoholicity to 0.5 v/v % or more and 4.5 v/v % or less, and the content of 3-methylbutanal to 0.1 ppb by mass or more and 8 ppb by mass or less. Hereinafter, as a method of producing a general beer-taste beverage, production methods with or without using a malt as a raw material are shown. Incidentally, the step of adjusting an alcoholicity to 0.5 v/v % or more and 4.5 v/v % or less, and the content of 3-methylbutanal to 0.1 ppb by mass or more and 8 ppb by mass or less can be controlled by the various methods mentioned above. In addition, adjustment of an alcoholicity and the content of 3-methylbutanal may be carried out simultaneously or separately.

The beer-taste beverage of the fourth embodiment of the present invention can be produced in a similar method to those of a general beer-taste beverage, except that the method includes adjusting an alcoholicity to 0.5 v/v % or more and 4.5 v/v % or less, and the content of phenylacetaldehyde to 0.1 ppb by mass or more and 65 ppb by mass or less. Hereinafter, as a method of producing a general beer-taste beverage, production methods with or without using a malt as a raw material are shown. Incidentally, the step of adjusting an alcoholicity to 0.5 v/v % or more and 4.5 v/v % or less, and the content of phenylacetaldehyde to 0.1 ppb by mass or more and 65 ppb by mass or less can be controlled by the various methods mentioned above. In addition, adjustment of an alcoholicity and the content of phenylacetaldehyde may be carried out simultaneously or separately.

The beer-taste beverage of the fifth embodiment of the present invention can be produced in a similar method to those of a general beer-taste beverage, except that the method includes adjusting an alcoholicity to 0.5 v/v % or more and 4.5 v/v % or less, and the content of heptanal to 0.1 ppb by mass or more and 3.8 ppb by mass or less. Hereinafter, as a method of producing a general beer-taste beverage, production methods with or without using a malt as a raw material are shown. Incidentally, the step of adjusting an alcoholicity to 0.5 v/v % or more and 4.5 v/v % or less, and the content of heptanal to 0.1 ppb by mass or more and 3.8 ppb by mass or less can be controlled by the various methods mentioned above. In addition, adjustment of an alcoholicity and the content of heptanal may be carried out simultaneously or separately.

As to the beer-taste beverage containing alcohol produced by using a malt as a raw material, first, to a mixture containing raw materials such as wheat such as malts, optionally other grains, starches, sugars, a bittering agent or a colorant, and water, an enzyme such as amylase is optionally added, to carry out gelatinization or saccharification, and the mixture is filtered, to provide a saccharified liquid. Hops, a bittering agent or the like is optionally added to the saccharified liquid, and a mixture is boiled, to remove solid contents such as coagulated proteins in a clearing tank. As a substitute for this saccharified liquid, hops may be added to a hot water added with a malt extract, and the mixture may be boiled. The hops may be mixed at any stage from the beginning of boiling and before the termination of boiling. As the conditions in the saccharification step, the boiling step, the solid content removal step, and the like, known conditions may be used. As the conditions in the fermentation and storage of liquor steps, known conditions may be used. The fermentation liquid obtained is filtered, and a carbon dioxide gas is added to the filtrate obtained. Thereafter, a vessel is filled with a product, and subjected to a sterilizing step, to obtain an intended beer-taste beverage. Incidentally, a spirit derived from grains may be added as an alcohol ingredient. The spirit means liquors obtained by using grains such as wheat, rice, buckwheat, maize or the like as a raw material, fermenting the grains with a yeast, and further distilling the fermented product. Wheat is preferable as the grains which are used as a raw material of a spirit.

As to the beer-taste beverage containing alcohol which is produced without using malts as raw materials, a liquid sugar containing a carbon source, a nitrogen source as an amino acid-containing material other than wheat or malts, hops, a pigment, and the like are mixed together with a hot water, to provide a liquid sugar-containing solution. The liquid sugar-containing solution is boiled. When hops are used as raw materials, the hops may be mixed with the liquid sugar-containing solution during boiling, not before the beginning of boiling. As a substitute for this saccharified liquid, hops may be added to a hot water added with an extract using raw materials other than malts, and a mixture may be boiled. The hops may be mixed at any stage from the beginning of boiling to before the termination of boiling. As the conditions in the fermentation and storage of liquor steps, known conditions may be used. The fermentation liquid obtained is filtered, and a carbon dioxide gas is added to the filtrate obtained. Thereafter, a vessel is filled with a product, and subjected to a sterilizing step, to obtain an intended beer-taste beverage. Incidentally, a spirit derived from grains may be added as an alcohol ingredient.

For the beer-taste beverage which is not fermented and contains alcohol, an alcoholicity of the final product may be adjusted by adding alcohol for raw materials or the like, regardless of using or not using malts. Addition of alcohol for raw materials may be carried out in any steps from saccharification step to filling step. Incidentally, a spirit derived from grains may be further added as an alcohol ingredient.

As to the nonalcoholic beer-taste beverage produced by using malts as raw materials, first, to a mixture containing raw materials such as wheat such as malts, optionally other grains, starches, sugars, a bittering agent, or a colorant, and water, an enzyme such as amylase optionally may be added, to carry out gelatinization or saccharification, and the mixture is filtered, to provide a saccharified liquid. Hops, a bittering agent or the like is optionally added to the saccharified liquid, and a mixture is boiled, to remove solid contents such as coagulated proteins in a clearing tank. As a substitute for this saccharified liquid, hops may be added to a hot water added with a malt extract, and a mixture may be boiled. The hops may be mixed at any stage from the beginning of boiling and before the termination of boiling. As the conditions in the saccharification step, the boiling step, the solid content removal step, and the like, known conditions may be used. After boiling, the hop-added product is cooled, and a flavor, an acidulant, a pigment such as a caramel pigment, an antioxidant, a bittering agent, a sweetener, an amino acid raw material, and the like are added to the wort obtained, the mixture is filtrated, and a carbon dioxide gas is added to the filtrate obtained. Thereafter, a vessel is filled with a product, and subjected to a sterilizing step, to obtain an intended nonalcoholic beer-taste beverage.

In the case of producing a nonalcoholic beer-taste beverage without using malts as raw materials, at first, a liquid sugar containing a carbon source, a nitrogen source as an amino acid-containing material other than wheat or malts, hops, a pigment, and the like are mixed together with a hot water, to provide a liquid sugar-containing solution. The liquid sugar-containing solution is boiled. When hops are used as raw materials, the hops may be mixed with the liquid sugar-containing solution during boiling, not before the beginning of boiling. After boiling, the hop-added product is cooled, and a flavor, an acidulant, a pigment such as a caramel pigment, an antioxidant, a bittering agent, a sweetener, an amino acid raw material, and the like are added to the wort obtained, the mixture is filtrated, and a carbon dioxide gas is added to the liquid sugar-containing solution obtained. Thereafter, a vessel is filled with a product, and subjected to a sterilizing step, to obtain an intended nonalcoholic beer-taste beverage.

In addition, when the beer-taste beverages are obtained according to the production method of the present invention, the beer-taste beverage of the first embodiment has fresh aftertaste, the beer-taste beverage of the second embodiment has an inhibited wort odor, the beer-taste beverage of the third embodiment has an inhibited cheese-like smell, the beer-taste beverage of the fourth embodiment has an inhibited honey-like smell, and the beer-taste beverage of the fifth embodiment has an inhibited immature odor. Accordingly, the present invention also provides a method of making the aftertaste of the beer-taste beverage fresh, a method of inhibiting the wort odor in the beer-taste beverage, a method of inhibiting the cheese-like smell in the beer-taste beverage, a method of inhibiting the honey-like smell in the beer-taste beverage, and a method of inhibiting the immature odor in the beer-taste beverage.

### EXAMPLES

The present invention will be specifically described hereinbelow by the Examples, without intending to limit the scope of the present invention to the following Examples.

### First Embodiment

### Examples 1 to 9, and Comparative Example 1

Beer-taste beverages were produced so as to have a composition shown in Table 1 using a raw material having 100% by mass of malts. Specifically, pulverized malts were mixed with hot water, to provide a saccharified liquid, and at this time the saccharified liquid was produced in a state in which temperature and time were adjusted and a saccharification action of β-amylase which malts have was properly adjusted. The saccharified liquid was filtrated, and then wort was boiled for 90 minutes. Thereafter, sediments were separated in a precipitation tank, and then the wort was cooled to provide cooled wort. Lager yeast was added thereto, the mixture was fermented according to an ordinary method, carbon dioxide gas was added to the fermented product in a proper amount, and the product was subjected to a filtration/bottling steps, to provide beer-taste beverages.

### <Sensory Evaluations>

As to evaluations of the above obtained beer-taste beverage, identical five panelists tasted each of beverages and evaluated the beverages according to the following basis.

Each panelist tasted 350 mL of the beer-taste beverage cooled to 4° C. or so, and evaluated the evaluation items of “freshness of aftertaste” and “body” ranging from 3.0 (maximum) to 1.0 (minimum) with increment of 0.1 of score, on the basis of the following score basis. The means of scores by five panelists were calculated and the 1.5 or more was considered as passed. The means are shown in Table 1. Upon evaluation, samples of which evaluation items fall under each of the following bases “1.0,” “20” and “310” were previously prepared, and uniformity of bases was attempted among each panelists. In addition, in sensory evaluations of all Examples and Comparative Examples, differences of 2.0 or more of score were not acknowledged for the same beverage among each panelist.

### <Freshness of Aftertaste>

“1.0”: Not tasted.
“1.5”: Hardly tasted.
“2.0”: Tasted.
“2.5”: Distinctively tasted.
“3.0”: Strongly tasted.

### <Body>

“1.0”: Not tasted.
“1.5”: Hardly tasted.
“2.0”: Tasted.
“2.5”: Distinctively tasted.
“3.0”: Strongly tasted.

TABLE 1
Table 1

| | | | Ex. | Ex | Ex. | Ex. | Com. Ex. | Ex. | Ex. | Ex. | Ex. | Ex |
|---|---|---|---|---|---|---|---|---|---|---|---|---|
| | | Unit | 1 | 2 | 3 | 4 | 1 | 5 | 6 | 7 | 8 | 9 |
| Malt Use Ratio | | % | 100 | 100 | 100 | 100 | 100 | 100 | 100 | 100 | 30 | 100 |
| Product | Alcoholicity | v/v % | 2.2 | 2.2 | 2.2 | 2.2 | 2.2 | 2.2 | 1.1 | 0.9 | 2.3 | 3.6 |
| Analysis | R-Ex | w/w % | 5.9 | 5.9 | 5.9 | 5.9 | 5.9 | 1.7 | 3.0 | 2.5 | 5.7 | 9.0 |
| Value | Apparent | % | 45 | 45 | 45 | 45 | 45 | 82 | 45 | 45 | 48 | 46 |
| | Attenuation | | | | | | | | | | | |
| | Total Nitrogen | mg/L | 520 | 520 | 520 | 520 | 520 | 350 | 260 | 220 | 150 | 920 |
| | Total Polyphenol | mg/L | 150 | 150 | 150 | 150 | 150 | 80 | 80 | 60 | 60 | 250 |
| | Proline | mg/L | 360 | 360 | 360 | 360 | 360 | 200 | 180 | 150 | 120 | 700 |
| | Isobutyraldehyde | ppb by | 6 | 8 | 10 | 12 | 14 | 8 | 8 | 8 | 8 | 10 |
| | | Mass | | | | | | | | | | |
| Result of | Freshness of | — | 2.6 | 2.5 | 2.2 | 1.8 | 1.4 | 2.8 | 2.7 | 2.8 | 2.8 | 2.2 |
| Sensory | Aftertaste | | | | | | | | | | | |
| Evaluation | Body | — | 2.4 | 2.4 | 2.4 | 2.4 | 2.4 | 1.3 | 2.3 | 2.1 | 2.1 | 2.9 |

As shown in Table 1, in the beer-taste beverages having an alcoholicity of 0.5 v/v % or more and 4.5 v/v % or less, all of Examples 1 to 9 of which the content of isobutyraldehyde was 0.1 ppb by mass or more and 13 ppb by mass or less had excellent freshness of aftertaste, as compared to Comparative Example 1.

### Second Embodiment

### Examples 21 to 28, and Comparative Examples 21 and 22

Beer-taste beverages were produced so as to have a composition shown in Table 2, and sensory evaluations were carried out in the same manner as the first embodiment, except that the evaluations were carried out according the following score bases.

### <Wort Odor>

“1.0”: Not tasted.
“1.5”: Hardly tasted.
“2.0”: Tasted.
“2.5”: Distinctively tasted.
“3.0”: Strongly tasted.

TABLE 2
Table 2

| | | | Ex. | Ex. | Ex. | Com. Ex. | Com. Ex. | Ex. | Ex. | Ex. | Ex. | Ex. |
|---|---|---|---|---|---|---|---|---|---|---|---|---|
| | | Unit | 21 | 22 | 23 | 21 | 22 | 24 | 25 | 26 | 27 | 28 |
| Malt Use Ratio | | % | 100 | 100 | 100 | 100 | 100 | 100 | 100 | 100 | 30 | 100 |
| Product | Alcoholicity | v/v % | 2.2 | 2.2 | 2.2 | 2.2 | 2.2 | 2.2 | 1.1 | 0.9 | 2.3 | 3.6 |
| Analysis Value | R-Ex | w/w % | 5.9 | 5.9 | 5.9 | 5.9 | 5.9 | 1.7 | 3.0 | 2.5 | 5.7 | 9.0 |
| | Apparent | % | 45 | 45 | 45 | 45 | 45 | 82 | 45 | 45 | 48 | 46 |
| | Attenuation | | | | | | | | | | | |
| | Total Nitrogen | mg/L | 520 | 520 | 520 | 520 | 520 | 350 | 260 | 220 | 150 | 920 |
| | Total Polyphenol | mg/L | 150 | 150 | 150 | 150 | 150 | 80 | 80 | 60 | 60 | 250 |
| | Proline | mg/L | 360 | 360 | 360 | 360 | 360 | 200 | 180 | 150 | 120 | 700 |
| | 2-Methylbutanal | ppb by | 1.8 | 2.2 | 2.6 | 3.0 | 3.4 | 2.2 | 2.2 | 2.2 | 2.2 | 2.6 |
| | | Mass | | | | | | | | | | |
| Result of Sensory | Wort Odor | — | 1.1 | 1.2 | 1.7 | 1.9 | 2.3 | 1.2 | 1.2 | 1.1 | 11 | 1.4 |
| Evaluation | Body | — | 2.5 | 2.5 | 2.4 | 2.4 | 2.4 | 1.2 | 2.1 | 2.1 | 2.1 | 2.8 |

As shown in Table 2, in the beer-taste beverages having an alcoholicity of 0.5 v/v % or more and 4.5 v/v % or less, the wort odor was inhibited in all of Examples 21 to 28 of which the content of 2-methylbutanal was 0.1 ppb by mass or more and 2.8 ppb by mass or less, as compared to Comparative Examples 21 and 22.

### Third Embodiment

### Examples 31 to 38, and Comparative Examples 31 and 32

Beer-taste beverages were produced so as to have a composition shown in Table 3, and sensory evaluations were carried out in the same manner as the first embodiment, except that the evaluations were carried out according the following score bases.

### <Cheese-Like Smell>

“1.0”: Not tasted.
“1.5”: Hardly tasted.
“2.0”: Tasted,
“2.5”: Distinctively tasted.
“3.0” Strongly tasted.

TABLE 3

| | | | Ex. | Ex. | Ex. | Com. Ex. | Com. Ex. | Ex. | Ex. | Ex | Ex. | Ex. |
|---|---|---|---|---|---|---|---|---|---|---|---|---|
| | | Unit | 31 | 32 | 33 | 31 | 32 | 34 | 35 | 36 | 37 | 38 |
| Malt Use Ratio | | % | 100 | 100 | 100 | 100 | 100 | 100 | 100 | 100 | 30 | 100 |
| Product | Alcoholicity | v/v % | 2.2 | 2.2 | 2.2 | 2.2 | 2.2 | 2.2 | 1.1 | 0.9 | 2.3 | 3.6 |
| Analysis | R-Ex | w/w % | 5.9 | 5.9 | 5.9 | 5.9 | 5.9 | 1.7 | 3.0 | 2.5 | 5.7 | 9.0 |
| Value | Apparent | % | 45 | 45 | 45 | 45 | 45 | 82 | 45 | 45 | 48 | 46 |
| | Attenuation | | | | | | | | | | | |
| | Total Nitrogen | mg/L | 520 | 520 | 520 | 520 | 520 | 350 | 260 | 220 | 150 | 920 |
| | Total Polyphenol | mg/L | 150 | 150 | 150 | 150 | 150 | 80 | 80 | 60 | 60 | 250 |
| | Proline | mg/L | 360 | 360 | 360 | 360 | 360 | 200 | 180 | 150 | 120 | 700 |
| | 3-Methylbutanal | ppb by | 3 | 5 | 7 | 9 | 11 | 5 | 5 | 5 | 5 | 7 |
| | | Mass | | | | | | | | | | |
| Result of | Cheese-Like | — | 1.0 | 1.3 | 1.9 | 2.6 | 2.9 | 1.4 | 1.3 | 1.0 | 1.1 | 1.9 |
| Sensory | Smell | | | | | | | | | | | |
| Evaluation | Body | — | 2.5 | 2.5 | 2.4 | 2.4 | 2.4 | 1.2 | 2.1 | 2.1 | 2.1 | 2.9 |

As shown in Table 3, in the beer-taste beverages having an alcoholicity of 0.5 v/v % or more and 4.5 v/v % or less, the cheese-like smell was inhibited in all of Examples 31 to 38 of which the content of 3-methylbutanal was 0.1 ppb by mass or more and 8 ppb by mass or less, as compared to Comparative Examples 31 and 32.

### Fourth Embodiment

Examples 41 to 49, and Comparative Example 41 Beer-taste beverages were produced so as to have a composition shown in Table 4, and sensory evaluations were carried out in the same manner as the first embodiment, except that the evaluations were carried out according the following score bases.

### <Honey-Like Smell>

“1.0”: Not tasted.
“1.5”: Hardly tasted.
“2.0” Tasted.
“2.5”: Distinctively tasted.
“3.0”: Strongly tasted.

TABLE 4
Table 4

| | | | Ex | Ex. | Ex. | Ex. | Com. Ex. | Ex | Ex, | Ex. | Ex. | Ex. |
|---|---|---|---|---|---|---|---|---|---|---|---|---|
| | | Unit | 41 | 42 | 43 | 44 | 41 | 45 | 46 | 47 | 48 | 49 |
| Malt Use Ratio | | % | 100 | 100 | 100 | 100 | 100 | 100 | 100 | 100 | 30 | 100 |
| Product | Alcoholicity | v/v % | 2.2 | 2.2 | 2.2 | 2.2 | 2.2 | 2.2 | 1.1 | 0.9 | 2.3 | 3.6 |
| Analysis | R-Ex | w/w % | 5.9 | 5.9 | 5.9 | 5.9 | 5.9 | 1.7 | 3.0 | 2.5 | 5.7 | 9.0 |
| Value | Apparent Attenuation | % | 45 | 45 | 45 | 45 | 45 | 82 | 45 | 45 | 48 | 46 |
| | Total Nitrogen | mg/L | 520 | 520 | 520 | 520 | 520 | 350 | 260 | 220 | 150 | 920 |
| | Total Polyphenol | mg/L | 150 | 150 | 150 | 150 | 150 | 80 | 80 | 60 | 60 | 250 |
| | Proline | mg/L | 360 | 360 | 360 | 360 | 360 | 200 | 180 | 150 | 120 | 700 |
| | Phenylacetaldehyde | ppb by | 30 | 40 | 50 | 60 | 70 | 40 | 40 | 40 | 40 | 55 |
| | | Mass | | | | | | | | | | |
| Result of | Honey-Like Smell | — | 1.0 | 1.2 | 1.6 | 1.9 | 2.5 | 1.2 | 1.2 | 1.2 | 1.0 | 1.9 |
| Sensory | | | | | | | | | | | | |
| Evaluation | Body | — | 2.5 | 2.4 | 2.3 | 2.1 | 2.1 | 1.1 | 2.0 | 2.1 | 2.1 | 2.9 |

As shown in Table 4, in the beer-taste beverages having an alcoholicity of 0.5 v/v % or more and 4.5 v/v % or less, the honey-like smell was inhibited in all of Examples 41 to 49 of which the content of phenylacetaldehyde was 0.1 ppb by mass or more and 65 ppb by mass or less, as compared to Comparative Example 41.

### Fifth Embodiment

Examples 51 to 58, and Comparative Examples 51 and 52 Beer-taste beverages were produced so as to have a composition shown in Table 5, and sensory evaluations were carried out in the same manner as the first embodiment, except that the evaluations were carried out according the following score bases.

### <Immature Odor>

“1.0”: Not tasted.
“1.5”: Hardly tasted.
“2.0”: Tasted.
“2.5”: Distinctively tasted.
“3.0”: Strongly tasted.

TABLE 5
Table 5

| | | | Ex. | Ex. | Ex. | Com, Ex. | Com. Ex. | Ex. | Ex | Ex. | Ex. | Ex. |
|---|---|---|---|---|---|---|---|---|---|---|---|---|
| | | Unit | 51 | 52 | 53 | 51 | 52 | 54 | 55 | 56 | 57 | 58 |
| Malt Use Ratio | | % | 100 | 100 | 100 | 100 | 100 | 100 | 100 | 100 | 30 | 100 |
| Product | Alcoholicity | v/v % | 2.2 | 2.2 | 2.2 | 2.2 | 2.2 | 2.2 | 1.1 | 0.9 | 2.3 | 3.6 |
| Analysis | R-Ex | w/w % | 5.9 | 5.9 | 5.9 | 5.9 | 5.9 | 1.7 | 3.0 | 2.5 | 5.7 | 9.0 |
| Value | Apparent | % | 45 | 45 | 45 | 45 | 45 | 82 | 45 | 45 | 48 | 46 |
| | Attenuation | | | | | | | | | | | |
| | Total Nitrogen | mg/L | 520 | 520 | 520 | 520 | 520 | 350 | 260 | 220 | 150 | 920 |
| | Total Polyphenol | mg/L | 150 | 150 | 150 | 150 | 150 | 80 | 80 | 60 | 60 | 250 |
| | Proline | mg/L | 360 | 360 | 360 | 360 | 360 | 200 | 180 | 150 | 120 | 700 |
| | beptanal | ppb by | 2.5 | 3.0 | 3.5 | 4.0 | 4.5 | 3.0 | 3.0 | 3.0 | 3.0 | 3.0 |
| | | Mass | | | | | | | | | | |
| Result of | Immature Odor | — | 1.1 | 1.5 | 1.9 | 2.6 | 2.9 | 1.3 | 1.4 | 1.2 | 1.1 | 1.7 |
| Sensory | | | | | | | | | | | | |
| Evaluation | Body | — | 2.5 | 2.4 | 2.4 | 2.3 | 2.3 | 1.1 | 2.1 | 2.1 | 2.1 | 2.9 |

As shown in Table 5, in the beer-taste beverages having an alcoholicity of 0.5 v/v % or more and 4.5 v/v % or less, immature odor was inhibited in all of Examples 51 to 58 of which the content of heptanal was 0.1 ppb by mass or more and 3.8 ppb by mass or less, as compared to Comparative Examples 51 and 52.

### INDUSTRIAL APPLICABILITY

According to the first embodiment of the present invention, a beer-taste beverage having a novel taste in which an aftertaste is fresh can be provided.

According to the second embodiment of the present invention, a beer-taste beverage having a novel taste in which a wort odor is inhibited can be provided.

According to the third embodiment of the present invention, a beer-taste beverage having a novel taste in which a cheese-like smell is inhibited can be provided.

According to the fourth embodiment of the present invention, a beer-taste beverage having a novel taste in which a honey-like smell is inhibited can be provided.

According to the fifth embodiment of the present invention, a beer-taste beverage having a novel taste in which an immature odor is inhibited can be provided.

1. A beer-taste beverage wherein an alcoholicity is 0.5 v/v % or more and 4.5 v/v % or less, and the content of isobutyraldehyde is 0.1 ppb by mass or more and 13 ppb by mass or less.

2. A beer-taste beverage wherein an alcoholicity is 0.5 v/v % or more and 4.5 v/v % or less, and the content of 2-methylbutanal is 0.1 ppb by mass or more and 2.8 ppb by mass or less.

3. A beer-taste beverage wherein an alcoholicity is 0.5 v/v % or more and 4.5 v/v % or less, and the content of 3-methylbutanal is 0.1 ppb by mass or more and 8 ppb by mass or less.

4. A beer-taste beverage wherein an alcoholicity is 0.5 v/v % or more and 4.5 v/v % or less, and the content of phenylacetaldehyde is 0.1 ppb by mass or more and 65 ppb by mass or less.

5. A beer-taste beverage wherein an alcoholicity is 0.5 v/v % or more and 4.5 v/v % or less, and the content of heptanal is 0.1 ppb by mass or more and 3.8 ppb by mass or less.

6. The beer-taste beverage according to claim 1, wherein a real extract (R-Ex) concentration is 1.5 w/w % or more.

7. The beer-taste beverage according to claim 1, wherein the content of proline is from 10 to 800 mg/L.

8. The beer-taste beverage according claim 1, wherein an apparent attenuation is 16% or more and 80% or less.

9. The beer-taste beverage according to claim 1, wherein a total nitrogen amount is from 100 to 2,000 mg/L.

10. The beer-taste beverage according to claim 1, wherein a total polyphenol amount is from 20 to 400 mg/100 mL.

11. A method of producing a beer-taste beverage, comprising adjusting an alcoholicity to 0.5 v/v % or more and 4.5 v/v % or less, and the content of isobutyraldehyde to 0.1 ppb by mass or more and 13 ppb by mass or less.

12. A method of producing a beer-taste beverage, comprising adjusting an alcoholicity to 0.5 v/v % or more and 4.5 v/v % or less, and the content of 2-methylbutanal to 0.1 ppb by mass or more and 2.8 ppb by mass or less.

13. A method of producing a beer-taste beverage, comprising adjusting an alcoholicity to 0.5 v/v % or more and 4.5 v/v % or less, and the content of 3-methylbutanal to 0.1 ppb by mass or more and 8 ppb by mass or less.

14. A method of producing a beer-taste beverage, comprising adjusting an alcoholicity to 0.5 v/v % or more and 4.5 v/V % or less, and the content of phenylacetaldehyde to 0.1 ppb by mass or more and 65 ppb by mass or less.

15. A method of producing a beer-taste beverage, comprising adjusting an alcoholicity to 0.5 v/v % or more and 4.5 v/v % or less, and the content of heptanal to 0.1 ppb by mass or more and 3.8 ppb by mass or less.

16. The method according to claim 11, wherein a real extract (R-Ex) concentration of the beer-taste beverage is 1.5 w/w % or more.

17. A method of making an aftertaste of a beer-taste beverage fresh, comprising adjusting an alcoholicity to 0.5 v/v % or more and 4.5 v/v % or less, and the content of isobutyraldehyde to 0.1 ppb by mass or more and 13 ppb by mass or less.

18. A method of inhibiting a wort odor in a beer-taste beverage, comprising adjusting an alcoholicity to 0.5 v/v % or more and 4.5 v/v % or less, and the content of 2-methylbutanal to 0.1 ppb by mass or more and 2.8 ppb by mass or less.

19. A method of inhibiting a cheese-like smell in a beer-taste beverage, comprising adjusting an alcoholicity to 0.5 v/v % or more and 4.5 v/v % or less, and the content of 3-methylbutanal to 0.1 ppb by mass or more and 8 ppb by mass or less.

20. A method of inhibiting a honey-like smell in a beer-taste beverage, comprising adjusting an alcoholicity to 0.5 v/v % or more and 4.5 v/v % or less, and the content of phenylacetaldehyde to 0.1 ppb by mass or more and 65 ppb by mass or less.

21. A method of inhibiting an immature odor in a beer-taste beverage, comprising adjusting an alcoholicity to 0.5 v/v % or more and 4.5 v/v % or less, and the content of heptanal to 0.1 ppb by mass or more and 3.8 ppb by mass or less.

22. The method of claim 17, wherein a real extract (R-Ex) concentration of the beer-taste beverage is 1.5 w/w % or more.
